(19) United States
(12) Patent Application Publication
(10) Pub. No.: US 2023/0299442 A1
(43) Pub. Date: Sep. 21, 2023

(54) COVER MEMBER

(71) Applicant: YAZAKI CORPORATION, Tokyo (JP)

(72) Inventors: Naomichi Suzuki, Makinohara-shi (JP); Tatsuya Tsutazawa, Makinohara-shi (JP); Kenya Takii, Makinohara-shi (JP)

(21) Appl. No.: 18/173,020

(22) Filed: Feb. 22, 2023

(30) Foreign Application Priority Data
Mar. 16, 2022 (JP) 2022-041709

(51) Int. Cl. H01M 50/591; H01M 50/583

(52) U.S. Cl. CPC H01M 50/591; H01M 50/583

(57) ABSTRACT

A battery terminal cover includes: a base portion that is fixed to a recess of a battery and accommodates a battery terminal and a fuse unit; a first cover coupled to the base portion via a first hinge; a second cover coupled to the base portion via a second hinge; a first engagement portion provided between the base portion and the first cover and disposed close to a side wall of the recess to hold the first cover at a shielding position; a second engagement portion provided between the base portion and the second cover and disposed close to the side wall of the recess to hold the second cover at a shielding position; and a release operation portion provided only in the first engagement portion so as to protrude upward higher than the side wall of the recess.

### CROSS-REFERENCE TO RELATED APPLICATIONS

This application is based on and claims priority under 35 USC 119 from Japanese Patent Application No. 2022-041709 filed on Mar. 16, 2022, the contents of which are incorporated herein by reference.

### TECHNICAL FIELD

The present invention relates to a cover member.

### BACKGROUND ART

In related art, as a cover member for protecting a terminal protruding from a battery, for example, a battery cover disclosed in Patent Literature 1 is known. The battery cover includes a lower cover (base portion) disposed in the vicinity of a battery post of a battery, an upper cover assembled to the lower cover and accommodating a fuse unit connected to the battery post in an interior formed with the lower cover, and an opening and closing portion (cover) provided in the upper cover so as to be openable and closable and exposing the battery post in an open state. When so-called battery rolling occurs, the opening and closing portion is opened, and a booster cable can be connected to the exposed battery post.

### CITATION LIST

### Patent Literature

Patent Literature 1: JP2020-35648A

### SUMMARY OF INVENTION

In the battery cover disclosed in Patent Literature 1, the upper cover assembled to the lower cover includes a fixing portion and the opening and closing portion.

The fixing portion is formed in a case shape having an open lower face so as to cover the fuse unit accommodated in the lower cover, and is assembled to the lower cover via an engagement portion including a locking protrusion and a locking hole provided between the fixing portion and the lower cover.

The opening and closing portion is formed in a case shape having an open lower face so as to cover the battery post inserted through a post through hole of the lower cover and a post fastening portion of a battery terminal, and is provided in the fixing portion so as to be openable and closable via a hinge. In a closed state, such an opening and closing portion is held in the closed state via an engagement portion including a locking protrusion and a locking hole provided between the opening and closing portion and the lower cover.

Therefore, when the engagement portion provided between the lower cover and the opening and closing portion is detached to open the opening and closing portion, the engagement portion provided between the lower cover and the fixing portion may be erroneously detached and the upper cover is opened. When the upper cover is opened, the fuse unit that is energized may be touched.

The present invention has been made in view of the above circumstances, and an object of the present invention is to provide a cover member that prevents an engagement portion of a cover covering a fuse unit from being detached when a battery is mounted.

In order to achieve the above object, a cover member according to the present invention is characterized by the following feature. The cover member includes
a base portion that is fixed to a recess of a battery and accommodates a battery terminal and a fuse unit;
a first cover that is coupled to the base portion via a first hinge and is configured to be rotationally displaceable between a first shielding position at which the first cover covers the battery terminal and a first exposed position at which the battery terminal is exposed;
a second cover that is coupled to the base portion via a second hinge and is configured to be rotationally displaceable between a second shielding position at which the second cover covers the fuse unit attached to the battery terminal and a second exposed position at which the fuse unit is exposed,
a first engagement portion that is provided between the base portion and the first cover, and is disposed close to a side wall of the recess to hold the first cover at the first shielding position;
a second engagement portion that is provided between the base portion and the second cover and is disposed close to the side wall of the recess to hold the second cover at the second shielding position; and
a release operation portion that is provided only in the first engagement portion so as to protrude upward higher than the side wall of the recess

According to the cover member of the present invention, the engagement portion of the cover covering the fuse unit can be prevented from being detached when the battery is mounted.

The present disclosure has been briefly described above. Further, details of the present disclosure will be further clarified by reading through a mode for carrying out the invention described below (hereinafter referred to as an “embodiment”) with reference to the accompanying drawings.

### BRIEF DESCRIPTION OF DRAWINGS

Exemplary embodiment(s) of the present invention will be described in detail based on the following figures, wherein:

FIG. 1 is a perspective view showing a cover member according to a first embodiment of the present invention assembled to a recess of a battery;

FIG. 2 is a perspective view of the cover member shown in FIG. 1 as viewed from an opposite side;

FIG. 3 is an exploded perspective view showing a battery terminal and a fuse unit accommodated in the cover member:

FIG. 4 is a perspective view of the cover member as viewed from above;

FIG. 5 is a perspective view showing a state in which a first cover and a second cover of the cover member shown in FIG. 1 are opened:

FIG. 6 is a front view of the cover member assembled to the recess of the battery;

FIG. 7 is a sectional view taken along a line VII-VII of FIG. 6;

FIG. 8 is a sectional view taken along a line VIII-VIII of FIG. 7; and

FIG. 9 is a perspective view showing a state immediately before a booster cable is connected with the first cover of the cover member shown in FIG. 2 being opened.

### DESCRIPTION OF EMBODIMENTS

A specific embodiment of the presently disclosed subject matter will be described below with reference to the drawings.

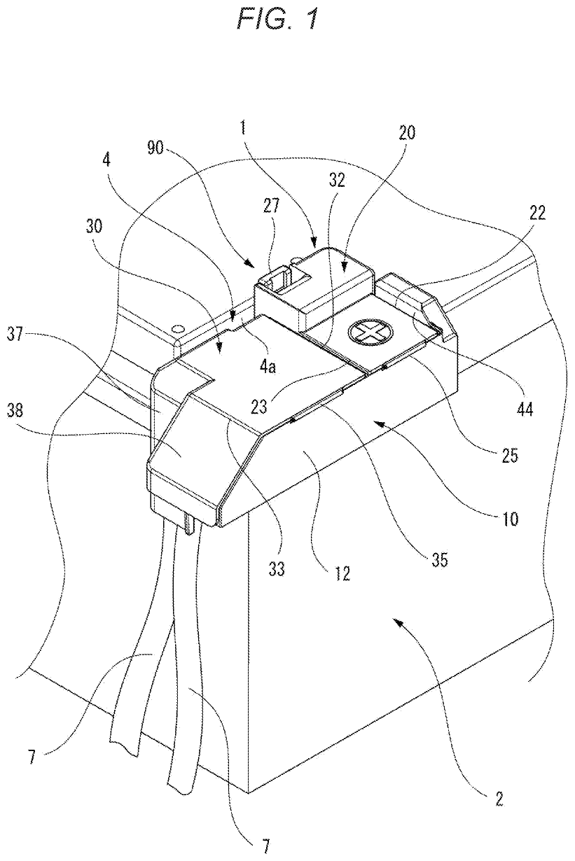

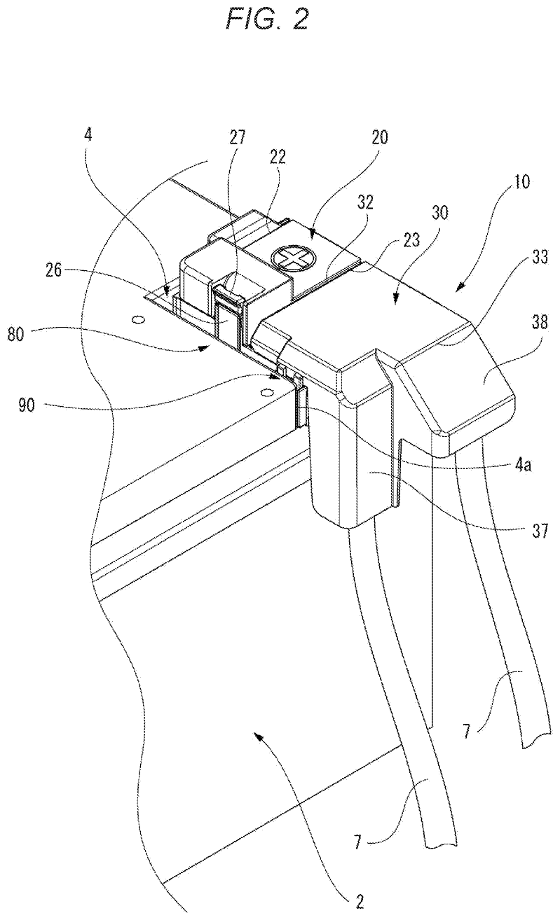

As shown in FIGS. 1 and 2, a battery terminal cover 1 as a cover member according to an embodiment of the present invention is mounted on an upper face side of a battery 2, and covers and protects a battery post 3 and a power connection system 5.

In the present description, an upper side of the battery terminal cover 1 in the state shown in FIG. 1 will be described as an upper side.

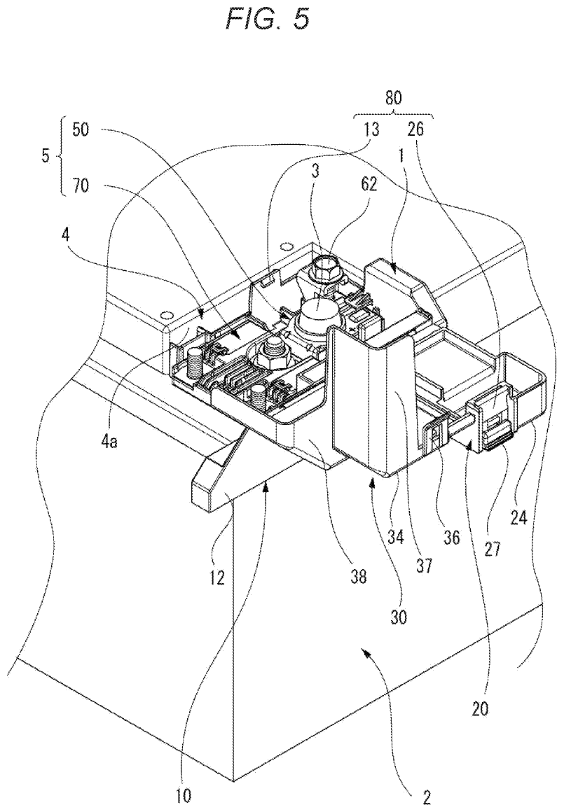

As shown in FIGS. 1 and 2, the battery 2 is formed in a rectangular parallelepiped shape, and a recess 4 formed by cutting the battery 2 so as to be one step lower from an upper face is provided in a corner portion of the upper face. A battery post 3 protrudes into the recess 4 described above of the battery 2 (see FIG. 5), and the power connection system 5 is connected to the battery post 3.

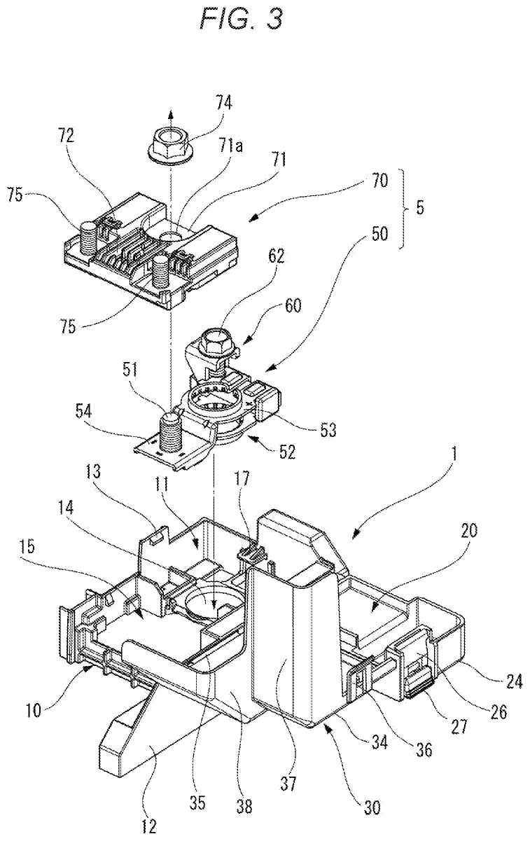

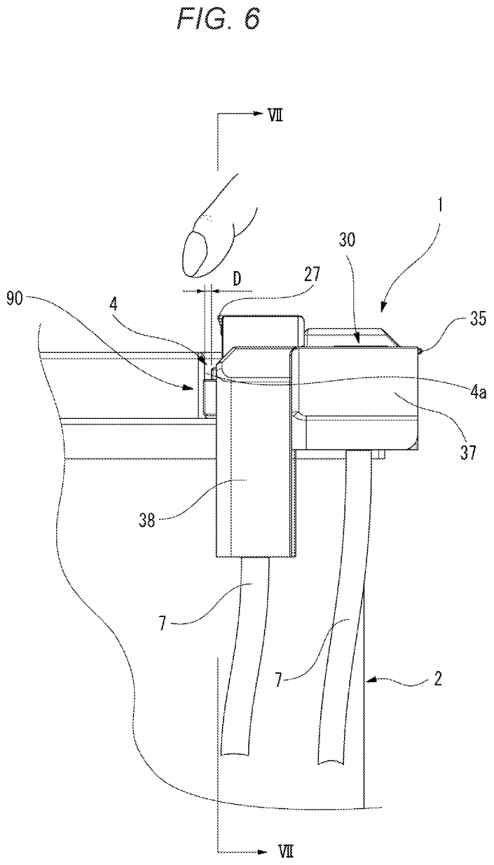

As shown in FIG. 3, the power connection system 5 of the present embodiment includes a battery terminal 50 and a fuse unit 70. As shown in FIG. 5, the power connection system 5 is assembled to the battery 2 to be interposed between the battery post 3 on a positive electrode side and electric wires 7, and electrically connects the battery terminal 50 and a fuse circuit body 71 of the fuse unit 70 to the battery post 3 and the electric wires 7 (see FIG. 6). A battery terminal 50 is physically and electrically connected to the battery post 3 as described later.

As shown in FIG. 3, the battery terminal 50 includes a stud bolt 51, a body portion 52, and a fastening portion 60.

The stud bolt 51 is formed of a conductive metal or the like.

The body portion 52 includes a post fastening portion 53 and a bolt holding portion 54. The post fastening portion 53 is a portion to be fastened to the battery post 3 by a fastening portion 60 to be described later. The bolt holding portion 54 is a portion that holds the stud bolt 51 connected adjacent to the post fastening portion 53. The body portion 52 is integrally formed by, for example, press-bending a conductive metal plate.

The fastening portion 60 of the present embodiment is of a type in which, when the battery terminal 50 is fastened to the battery post 3, the fastening bolt 62 is fastened along the upper-lower direction along a central axis of the battery post 3.

As shown in FIG. 3, the fuse unit 70 includes a fuse circuit body 71 and a support member 72 that supports the fuse circuit body 71.

The support member 72 is formed of an insulating material such as a synthetic resin, and the fuse circuit body 71 is insert-molded.

The fuse circuit body 71 has a fuse element (not shown) on a conduction path between the battery terminal 50 side and the electric wire 7 side. The fuse circuit body 71 is fastened together with the battery terminal 50 by screwing the stud bolt 51 and the nut 74, and is physically and electrically connected to the battery terminal 50.

Therefore, the fuse circuit body 71 is formed with a through hole 71a through which the stud bolt 51 is inserted. Further, the fuse circuit body 71 is provided with two male screw members 75 electrically connected to each other. Therefore, the fuse circuit body 71 is fastened together with a connection terminal (not shown) connected to an end of the electric wire 7 by screwing the male screw members 75 and a nut (not shown), and is electrically connected to the electric wire 7.

The power connection system 5 including the battery terminal 50 and the fuse unit 70 is accommodated in the battery terminal cover 1 formed of an insulating material such as a synthetic resin.

As shown in FIGS. 1 and 2, the battery terminal cover 1 according to the first embodiment includes a base portion 10 fixed to the battery 2, a first cover 20 coupled to the base portion 10 via a first hinge 25, and a second cover 30 coupled to the base portion 10 via a second hinge 35.

As shown in FIGS. 3 to 5, the base portion 10 has a circular through hole 14 into which the battery post 3 protruding into the recess 4 of the battery 2 is inserted, and is installed in the recess 4 of the battery 2 such that the battery post 3 is inserted through the through hole 14.

A terminal accommodating chamber 11 for accommodating the battery terminal 50 is formed in the installed base portion 10. A free end side of the battery post 3 inserted into the through hole 14 is disposed in the terminal accommodating chamber 11. In the terminal accommodating chamber 11, the battery terminal 50 is placed on the base portion 10 while the battery post 3 is inserted from the free end side, and is maintained in an accommodated state by a locking structure such as a locking protrusion 17. The battery terminal 50 is physically and electrically connected to the free end side of the battery post 3 by the fastening portion 60.

Further, the base portion 10 is provided with a unit accommodating chamber 15 for accommodating the fuse unit 70. The fuse unit 70 is attached to the battery terminal 50 accommodated in the terminal accommodating chamber 11. Therefore, the stud bolt 51 of the battery terminal 50 accommodated in the terminal accommodating chamber 11 is disposed in the unit accommodating chamber 15. In the unit accommodating chamber 15, the stud bolt 51 is inserted into the through hole 71a of the fuse circuit body 71 of the fuse unit 70, the fuse circuit body 71 of the fuse unit 70 is placed on the battery terminal 50, and the support member 72 of the fuse unit 70 is placed on the base portion 10.

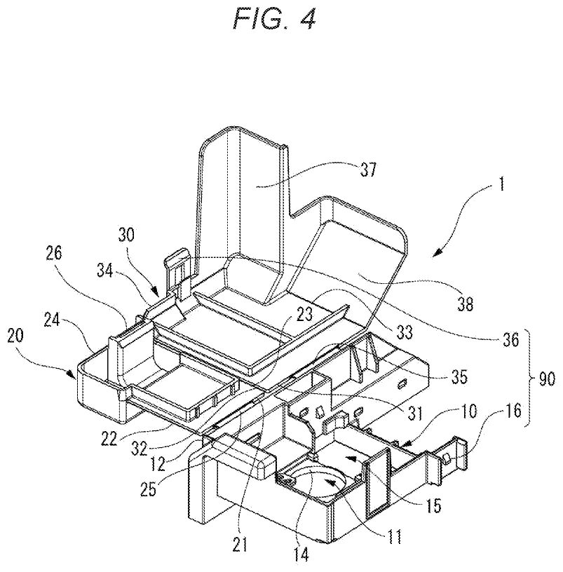

As shown in FIGS. 3 and 4, the first cover 20 is coupled to one side wall 12 of the base portion 10 via the first hinge 25, and can cover an upper opening of the terminal accommodating chamber 11 in an openable and closable manner. That is, the first cover 20 can be rotationally displaced to a shielding position at which the first cover 20 covers the post fastening portion 53 of the battery terminal 50 and the battery post 3 and to an exposed position at which the battery terminal 50 is exposed.

The first cover 20 is formed in a substantially rectangular plate shape having a base end side edge portion 21 coupled to the first hinge 25, a pair of width direction side edge portions 22 and 23 extending in parallel to each other from both ends of the base end side edge portion 21, and a rotation tip end portion 24 which is an opposing side of the base end side edge portion 21.

A lock arm 26 is provided at the rotation tip end portion 24 of the first cover 20. The first cover 20 is held at the shielding position by the lock arm 26 being locked to a locking protrusion 13 provided at a corresponding position of the base portion 10.

That is, between the base portion 10 and the first cover 20, there is provided a first engagement portion 80 which includes the locking protrusion 13 and the lock arm 26 and holds the first cover 20 at the shielding position.

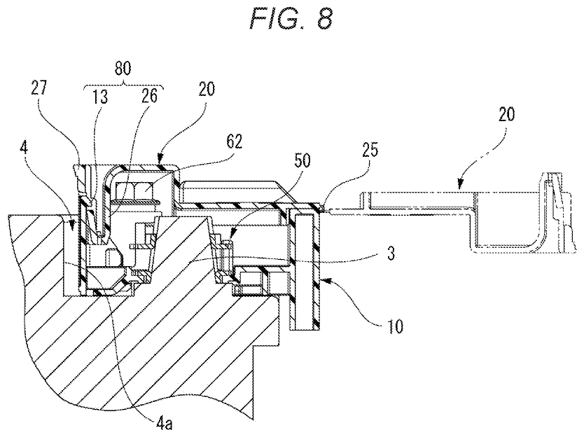

As shown in FIG. 8, when the first cover 20 is at the shielding position, the first hinge 25 is disposed on an outer surface side of the battery 2, and the first engagement portion 80 is disposed close to a side wall 4a of the recess 4.

Further, the lock arm 26 is provided with a release operation portion 27 protruding upward higher than the side wall 4a of the recess 4. The lock arm 26 is released form the lock due to the locking protrusion 13 by operating the release operation portion 27.

The second cover 30 arranged side by side with the first cover 20 is coupled to the one side wall 12 of the base portion 10 via the second hinge 35, and can cover an upper opening of the unit accommodating chamber 15 in an openable and closable manner. That is, the second cover 30 can be rotationally displaced to a shielding position at which the second cover 30 covers the fuse unit 70 attached to the battery terminal 50, and to an exposed position at which the fuse unit 70 is exposed.

As shown in FIGS. 3 and 4, the second cover 30 is formed in a substantially rectangular plate shape having a base end side edge portion 31 coupled to the second hinge 35, a pair of width direction side edge portions 32 and 33 extending in parallel to each other from both ends of the base end side edge portion 31, and a rotation tip end portion 34 which is an opposing side of the base end side edge portion 31.

A lock piece 36 is provided at the rotation tip end portion 34 of the second cover 30. The second cover 30 is held at the shielding position by the lock piece 36 being locked to a locking protrusion 16 provided at a corresponding position of the base portion 10.

That is, between the base portion 10 and the second cover 30, there is provided a second engagement portion 90 which includes the locking protrusion 16 and the lock piece 36 and holds the second cover 30 at the shielding position.

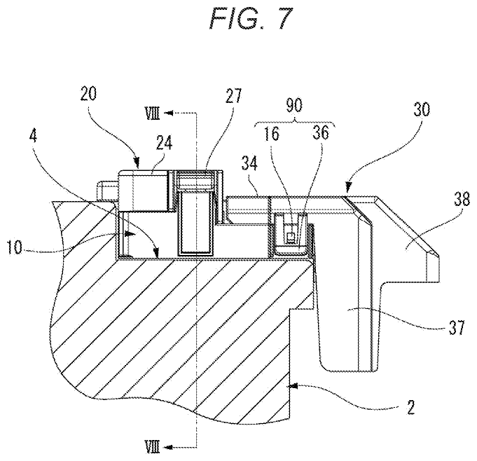

As shown in FIGS. 6 and 7, when the second cover 30 is at the shielding position, the second hinge 35 is disposed on the outer surface side of the battery 2, and the second engagement portion 90 is disposed close to the side wall 4a of the recess 4. Therefore, a finger cannot be inserted into a gap D between the side wall 4a of the recess 4 and the second engagement portion 90 which are disposed close to each other, so that the lock with the locking protrusion 16 is not released due to an operation on the lock piece 36. That is, the gap D between the side wall 4a of the recess 4 and the second engagement portion 90 which are disposed close to each other is a gap smaller than the finger.

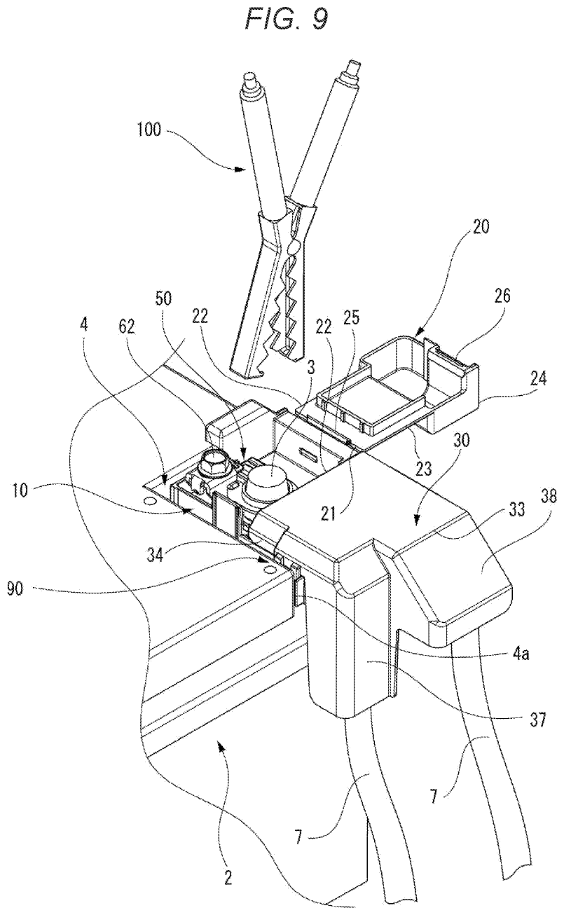

Therefore, according to the battery terminal cover 1 of the present embodiment, as shown in FIGS. 8 and 9, when the first cover 20 is opened and a booster cable 100 is connected to the exposed battery post 3, the first engagement portion 80 provided between the base portion 10 and the first cover 20 is to be detached. At this time, the first engagement portion 80 can be easily detached by operating the release operation portion 27.

In addition, since the lock piece 36 of the second engagement portion 90 cannot be operated by inserting a finger into the gap D between the side wall 4a of the recess 4 and the second engagement portion 90, it is possible to prevent the second cover 30 from being opened due to erroneous detachment of the second engagement portion 90 provided between the base portion 10 and the second cover 30.

Therefore, there is no possibility that the second cover 30 is opened and the fuse unit 70 which is energized is touched.

Further, in the battery terminal cover 1 according to the present embodiment, the first hinge 25 of the first cover 20 and the second hinge 35 of the second cover 30 are disposed on the outer surface side of the battery 2. Therefore, as shown in FIG. 8, since the first cover 20 and the second cover 30 are opened and closed to a side opposite to the side wall 4a of the recess 4, a movable region is improved.

Therefore, according to the battery terminal cover 1 of the embodiment, the second engagement portion 90 of the second cover 30 covering the fuse unit 70 can be prevented from being detached when the battery is mounted.

It should be noted that the present disclosure is not limited to the above embodiment, and modifications, improvements, and the like can be made as appropriate. In addition, materials, shapes, dimensions, numbers, arrangement positions, and the like of the respective constituent elements in the above embodiment are optionally selected and are not limited as long as the present disclosure can be implemented.

The configurations of the first engagement portion and the second engagement portion of the above embodiment are not limited to the configurations of the first engagement portion and the second engagement portion described above, and it is needless to say that various forms can be adopted.

Here, features of the cover member according to the embodiment of the present disclosure described above will be briefly summarized and listed in <1> below.

<1> A cover member (1) including:
a base portion (10) that is fixed to a recess (4) of a battery (2) and accommodates a battery terminal (50) and a fuse unit (70);
a first cover (20) that is coupled to the base portion (10) via a first hinge (25) and is configured to be rotationally displaceable between a first shielding position at which the first cover (20) covers the battery terminal (50) and a first exposed position at which the battery terminal (50) is exposed;
a second cover (30) that is coupled to the base portion (10) via a second hinge (35) and is configured to be rotationally displaceable between a second shielding position at which the second cover (30) covers the fuse unit (70) attached to the battery terminal (50) and a second exposed position at which the fuse unit (70) is exposed,
a first engagement portion (80) that is provided between the base portion (10) and the first cover (20), and is disposed close to a side wall (4a) of the recess (4) to hold the first cover (20) at the first shielding position;
a second engagement portion (90) that is provided between the base portion (10) and the second cover (30) and is disposed close to the side wall (4a) of the recess (4) to hold the second cover (30) at the second shielding position; and
a release operation portion (27) that is provided only in the first engagement portion (80) so as to protrude upward higher than the side wall (4a) of the recess (4).

According to the cover member (battery terminal cover 1) having the configuration of <1>, when the first cover (20) is opened and a booster cable (100) is connected to the exposed battery post (3), the first engagement portion (80) provided between the base portion (10) and the first cover (20) is to be detached. At this time, the first engagement portion (80) can be easily detached by operating the release operation portion (27).

In addition, since the lock piece (36) of the second engagement portion (90) cannot be operated by inserting a finger into the gap (D) between the side wall (4a) of the recess (4) and the second engagement portion (90), it is possible to prevent the second cover (30) from being opened due to erroneous detachment of the second engagement portion (90) provided between the base portion (10) and the second cover (30).

Therefore, there is no possibility that the second cover (30) is opened and the fuse unit (70) which is energized is touched.

What is claimed is:

1. A cover member comprising:
a base portion that is fixed to a recess of a battery and accommodates a battery terminal and a fuse unit;
a first cover that is coupled to the base portion via a first hinge and is configured to be rotationally displaceable between a first shielding position at which the first cover covers the battery terminal and a first exposed position at which the battery terminal is exposed;
a second cover that is coupled to the base portion via a second hinge and is configured to be rotationally displaceable between a second shielding position at which the second cover covers the fuse unit attached to the battery terminal and a second exposed position at which the fuse unit is exposed,
a first engagement portion that is provided between the base portion and the first cover, and is disposed close to a side wall of the recess to hold the first cover at the first shielding position;
a second engagement portion that is provided between the base portion and the second cover and is disposed close to the side wall of the recess to hold the second cover at the second shielding position; and
a release operation portion that is provided only in the first engagement portion so as to protrude upward higher than the side wall of the recess.
